(19) United States
(12) Patent Application Publication
(10) Pub. No.: US 2026/0032148 A1
(43) Pub. Date: Jan. 29, 2026

(54) GENERATION OF STATIC AND DYNAMIC SECRET KEYS TO PREVENT DISTRIBUTED DENIAL-OF-SERVICE ATTACKS

(71) Applicant: Roblox Corporation, San Mateo, CA (US)

(72) Inventors: Ravi I. SINGH, San Jose, CA (US); Lan WEI, San Mateo, CA (US); David STAHL, St. Louis, MO (US)

(73) Assignee: Roblox Corporation, San Mateo, CA (US)

(21) Appl. No.: 19/345,374

(22) Filed: Sep. 30, 2025

Related U.S. Application Data
(63) Continuation-in-part of application No. 18/794,535, filed on Aug. 5, 2024.
Application No. 18/794,535 is a continuation of application No. 17/704,767, filed on Mar. 25, 2022, now Pat. No. 12,081,585.

(51) Int. Cl. H04L 9/40; H04L 12/46; H04L 67/1001; H04L 67/1023; H04L 69/16

(52) U.S. Cl. CPC H04L 63/1458; H04L 63/0435; H04L 69/16; H04L 12/4641; H04L 63/0272; H04L 67/1001; H04L 67/1023

(57) ABSTRACT

A computer-implemented method performed at a processing server includes receiving, from a client device, a request to connect to an application server. The method further includes identifying a targeted application server from a set of application servers. The method further includes mapping a private internet protocol (IP) address for the targeted application server to a virtual IP (VIP) address associated with one or more demultiplexers. The method further includes generating a token based on a current secret key, wherein the token includes an indication of whether the token was generated using a static secret key or a particular dynamic secret key. The method further includes transmitting the VIP address, the private IP address, and the token to the client device.

### CROSS-REFERENCE TO RELATED APPLICATIONS

This application is a continuation—in part application under 35 U.S.C. § 120 of U.S. patent application Ser. No. 18/794,535, filed Aug. 5, 2024, entitled “Online Game Network Demultiplexer with Denial-of-Service Prevention,” which is a continuation under 35 U.S.C. § 120 of U.S. patent application Ser. No. 17/704,767, filed Mar. 25, 2022, entitled “Online Game Network Demultiplexer with Denial-of-Service Prevention” (now U.S. Pat. No. 12,081,585). U.S. patent application Ser. No. 18/794,535 and U.S. patent application Ser. No. 17/704,767 are incorporated by reference herein by their entirety.

### BACKGROUND

Embodiments relate generally to an online game network demultiplexer that prevents denial-of-service attacks. More particularly, but not exclusively, embodiments relate to using static and dynamic secret keys to prevent denial-of-service attacks.

Some online platforms (e.g. gaming platforms, media exchange platforms, etc.), allow users to connect with each other, interact with each other (e.g., within a game), create games, and share information with each other via the Internet. Users of online platforms may participate in multiplayer gaming environments or virtual environments (e.g., three-dimensional environments), design custom gaming environments, design characters and avatars, decorate avatars, exchange virtual items/objects with other users, communicate with other users using audio or text messaging, and so forth. Environments such as metaverse or multiverse environments can also enable users that participate to share, sell, or trade objects of their creation with other users.

Online multiplayer games typically depend on network communication between client devices and a central server that manages game servers. Game operators run many game servers for scale, with client devices partitioned among the game servers. Communications between game servers and client devices use User Datagram Protocol (UDP) because UDP prioritizes speed over reliability (as compared to, for example, Transmission Control Protocol (TCP)). Communications over UDP present two problems. First, giving each server a unique, public internet protocol (IP) address is an inefficient use of public IP address space, especially when IPv4 address space is such a scarce resource. Second, internet-facing servers are vulnerable to Distributed Denial of Service (DDOS) attacks.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect, a computer-implemented method performed at a processing server comprises receiving, from a client device, a request to connect to an application server. The method further includes identifying a targeted application server from a set of application servers. The method further includes mapping a private internet protocol (IP) address for the targeted application server to a virtual IP (VIP) address associated with one or more demultiplexers. The method further includes generating a token based on a current secret key, wherein the token includes an indication of whether the token was generated using a static secret key or a particular dynamic secret key. The method further includes transmitting the VIP address, the private IP address, and the token to the client device in response to the request.

In some embodiments, the token further includes a generation identifier for the current secret key and wherein responsive to the current secret key being the particular dynamic secret key, the generation identifier refers to the particular dynamic secret key from a set of dynamic secret keys. In some embodiments, the method further includes transmitting, to the one or more demultiplexers and the set of application servers, a configuration file that includes the static secret key and a set of dynamic secret keys including the particular dynamic secret key, where each dynamic secret key in the set of dynamic secret keys is associated with a corresponding generation identifier. In some embodiments, the method further includes updating the configuration file based on a change to a root static secret and a change to a root dynamic static secret and transmitting the updated configuration file to the one or more demultiplexers and the set of application servers. In some embodiments, the method further includes in response to an upcoming offline status of the processing server, transmitting a notification to the one or more demultiplexers to perform validation of tokens from using the particular dynamic secret key to using the static secret key. In some embodiments, the token includes a hash of a client device IP address of the client device, the private IP address for the targeted application server, and the current secret key. In some embodiments, identifying the targeted application server from the set of application servers is based on a client device IP address of the client device and selecting the targeted application server that is closest to a physical location of the client device as compared to other application servers in the set of application servers.

A system may include one or more processors and a memory coupled to the one or more processors, with instructions stored thereon that, when executed by the one or more processors, cause the one or more processors to perform or cause to be performed operations. The operations include receiving, from a processing server, a static secret key and a set of dynamic secret keys; receiving, from a client device, an ingress packet that includes a routing and authentication header; parsing the routing and authentication header to obtain a private IP address for a targeted application server and a token, wherein the token includes an indication of whether the token was generated using the static secret key or a particular dynamic secret key of the set of dynamic secret keys; determining, based on the indication of whether the token was generated using the static secret key or the particular dynamic secret key, whether the token is valid; responsive to determining that the token is valid, encapsulating the ingress packet to form an egress packet; and transmitting the egress packet to the targeted application server corresponding to the private IP address.

In some embodiments, the token is encoded with a generation identifier for the particular dynamic secret key and wherein determining whether the token is valid is further based on the generation identifier. In some embodiments, receiving the static secret key and the set of dynamic secret keys includes receiving the static secret key and the set of dynamic secret keys as part of a configuration file. In some embodiments, the operations further include receiving, from the processing server, an update to the configuration file and performing subsequent validations of tokens based on the update to the configuration file.

In some embodiments, determining whether the token is valid includes: calculating a hash of a client device IP address, the private IP address for the targeted application server, and the static secret key or the particular dynamic secret key based on the indication and comparing the token to the hash to confirm that both the token and the hash have equal values. In some embodiments, transmitting the egress packet to the targeted application server includes using a tunnel to forward the egress packet. In some embodiments, the operations further include responsive to determining that the token is invalid, performing one or more of dropping future ingress packets from the client device or automatically blocking a client device IP address. In some embodiments, the demultiplexer is one of a plurality of demultiplexers mapped to a Virtual IP (VIP) address; incoming packets are sharded among the plurality of demultiplexers; and each of the plurality of demultiplexers receives a configuration file that includes the static secret key and set of dynamic secret keys. In some embodiments, the operations further include receiving a notification from a processing server to perform a first validation of tokens using the static secret key and, responsive to the first validation failing, perform a second validation of the tokens using the particular dynamic secret key.

A non-transitory computer-readable medium with instructions stored thereon that, when executed by a client device, cause the client device to perform or cause to be performed operations. The operations include transmitting, to a processing server, a request to connect to an application server; receiving, from the processing server, a VIP address associated with a demultiplexer, a private IP address for a targeted application server, and a token generated using a current secret key, where the token includes an indication of whether the current secret key is a static secret key or a particular dynamic secret key; generating an ingress packet that includes a routing and authentication header with the token; transmitting, to the demultiplexer associated with the VIP address, the ingress packet, wherein the demultiplexer forwards an egress packet generated from the ingress packet to the targeted application server based on the private IP address; and receiving a communication from the targeted application server in response to the targeted application server receiving the egress packet.

In some embodiments, the client device transmits the request to connect to the application server using HyperText Transfer Protocol (HTTP) and wherein the client device transmits the ingress packet to the demultiplexer using User Datagram Protocol (UDP). In some embodiments, the token further includes a generation identifier for the current secret key and wherein responsive to the current secret key being the particular dynamic secret key, the generation identifier refers to the particular dynamic secret key from a set of dynamic secret keys. In some embodiments, the demultiplexer forwards the egress packet responsive to determining, using the current secret key, that the token is valid.

### BRIEF DESCRIPTION OF THE DRAWINGS

FIG. 1 is a block diagram illustrating an example network environment, according to some embodiments described herein.

FIG. 2A is a block diagram illustrating an example computing device for a processing application, according to some embodiments described herein.

FIG. 2B is a block diagram illustrating an example computing device for a demultiplexer, according to some embodiments described herein.

FIG. 3 is an example configuration file, according to some embodiments described herein.

FIG. 4 is an example flow diagram between a game client and a game server, according to some embodiments described herein.

FIG. 5 is a block diagram illustrating an example architecture for synchronizing a secret key, according to some embodiments described herein.

FIGS. 6A-6B are example flow diagrams of a method between a client device, a processing application, and a demultiplexer, according to some embodiments.

FIG. 7 is a flow diagram of an example method written from the processing server and demultiplexer perspectives, according to some embodiments described therein.

FIG. 8 is a flow diagram of an example method written from the processing server perspective, according to some embodiments described therein.

FIG. 9 is a flow diagram of an example method written from the demultiplexer perspective, according to some embodiments described therein.

FIG. 10 is a flow diagram of an example method written from the client device perspective, according to some embodiments described therein.

### DETAILED DESCRIPTION

### Overview

During a Distributed Denial of Service (DDOS) attack, a malicious actor spoofs a victim's Internet Protocol (IP) address and attempts to open connections with multiple servers. DDOS attacks overwhelm the servers with malicious traffic, leading to slow performance, inaccessibility, and service disruptions for legitimate client devices. Furthermore, DDOS attacks are unpredictable-they can occur at any time, necessitating a defense mechanism that remains operational and adaptable.

A replay attack is another type of network attack where packets may be intercepted, copied, and retransmitted by a malicious actor that is attempting to spoof a legitimate client device. Yet another type of network attack occurs when a malicious actor obtains access to source code of both an online business and its defense system. The malicious actor may spoof source addresses and generate packets that are indistinguishable from legitimate traffic. Lastly, malicious actors may reverse-engineer a root secret by analyzing large volumes of packet samples.

The technology described herein addresses the issues above by using both a static secret key and a dynamic secret key. The static secret key is a single secret key. The dynamic secret key is associated with a set of dynamic secret keys where a particular dynamic secret key is rotated from the set of dynamic secret keys. The secret key and the set of dynamic secret keys may be described in a configuration file. The configuration file may indicate whether a current secret key uses the static secret key or one of the dynamic secret keys. The dynamic secret keys may be identified with corresponding generation identifiers.

A processing application includes a pepper engine that generates and maintains the configuration file describing the static secret key and the set of dynamic secret keys. The processing application receives a request from a client device to connect to an application server (e.g., to play a game). The processing application generates a token based on a current secret key and provides the token to the client device to be used for authentication. The token is encoded with an indication of whether the current key is the static secret key or a particular dynamic secret key of the set of dynamic secret keys.

The processing application transmits the current secret key (e.g., as a configuration file) to pepper modules that are associated with application servers that provide client devices with applications (e.g., games) and demultiplexers that perform authentication of the token provided to the client device. A demultiplexer authenticates the token by using the indication of whether the token was generated using a static secret key or a particular dynamic secret key to determine the current secret key and identifies the current secret key from the configuration file. The demultiplexer validates the token by generating a hash from certain information (e.g., a client IP address of the client device, the private IP address for a targeted application server) and the current secret key and by determining if the hash matches the token. The processing application provides updates to the current secret key to the pepper modules to reduce the risk that a malicious actor will determine the current secret key and use it for malicious activities, such as spoofing packets.

The static secret key and the set of dynamic secret keys are advantageously used when a server is taken offline, for example, because the server is due for maintenance or during a DDOS attack. The processing application transmits a notification to the pepper modules that the current secret key is changed from a dynamic secret key to the static secret key. During this time, the processing application generates tokens from the static secret key and instructs the pepper modules to validate the tokens using the static secret key. Once the server is back online, the processing application enacts a multi-stage process of generating a new configuration file with a new static secret key and a new set of dynamic secret keys. The processing application may continue to generate tokens using the new static secret key but instruct the pepper modules to validate using either the new static secret key or one of the new dynamic secret keys. This addresses any issues with synchronization between the application servers and the demultiplexers. The final stage may be to revert to the processing application generating the token using the new dynamic static secret and instructing the pepper modules to validate using the new dynamic static secret.

### Network Environment

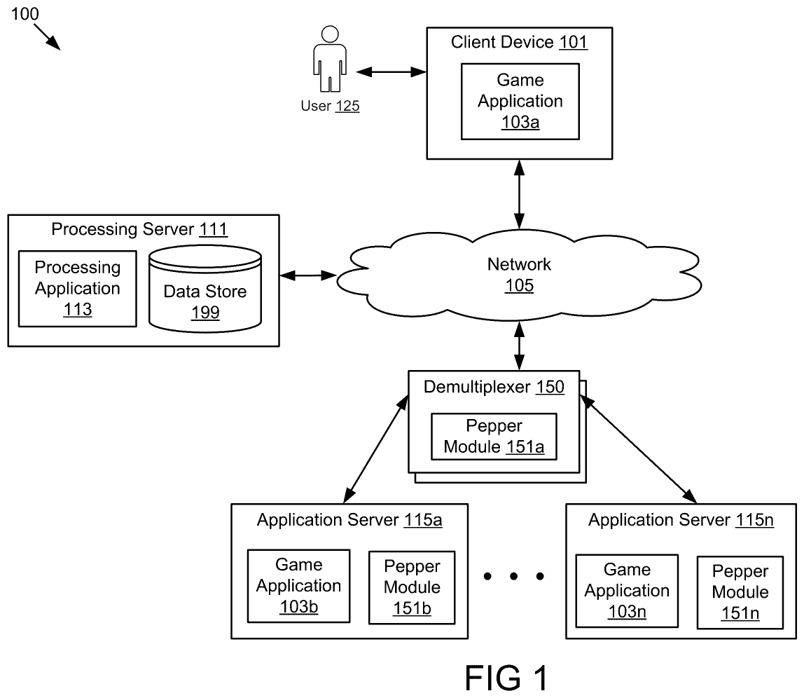

FIG. 1 illustrates a block diagram of an example environment 100. In some embodiments, the environment 100 includes a client device 101, a processing server 111, one or more demultiplexers 150, application servers 115a . . . n, and a network 105. A user 125 may be associated with the client device 101. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The processing server 111 includes a processor, a memory, and network communication hardware. In some embodiments, the processing server 111 may be a hardware server. The processing server 111 is communicatively coupled to the network 105. In some embodiments, the processing server 111 sends and receives data to and from the client device 101, the one or more demultiplexers 150, and the applications servers 115a . . . n via the network 105. The processing server 111 may include a processing application 113 and a data store 199.

In some embodiments, the processing application 113 includes code and routines operable to receive a request from the client device 101 to connect to the application server 115. The processing application 113 identifies a targeted application server 115, such as application server 115a, and generates a token based on a current secret key. In some embodiments, the token includes a hash of a client device 101 private IP address, a private IP address for the targeted application server 115a, and the current secret key. The current secret key may be a static secret key or a dynamic secret key. The token includes an indication of whether the token was generated using a static secret key or a dynamic secret key.

The processing application 113 maps a private Internet Protocol (IP) address for the targeted application server 115a to a Virtual Internet Protocol (VIP) address associated with the one or more demultiplexers 150. The processing application 113 transmits the VIP address, the private IP address and the port number associated with the targeted application server 115, and the token to the client device 101.

In some embodiments, the processing application 113 may be implemented using hardware including a central processing unit (CPU), a field-programmable gate array (FPGA), an application-specific integrated circuit (ASIC), any other type of processor, or a combination thereof. In some embodiments, the processing application 113 is implemented using a combination of hardware and software.

The data store 199 may be a non-transitory computer readable memory (e.g., random access memory), a cache, a drive (e.g., a hard drive), a flash drive, a database system, or another type of component or device capable of storing data. The data store 199 may also include multiple storage components (e.g., multiple drives or multiple databases) that may also span multiple computing devices (e.g., multiple server computers). The data store 199 may store data associated with the processing application 113, tokens, configuration files, secret keys (e.g., a static secret key, a set of dynamic secret keys, one or more root secrets, etc.), private IP addresses, port numbers, VIP addresses, etc.

The client device 101 may be a computing device that includes a memory and a hardware processor. For example, the client device 101 may include a desktop computer, a mobile device, a tablet computer, a mobile telephone, a wearable device, a portable game player, or another electronic device capable of accessing a network 105.

In some embodiments, the client device 101 includes a game application 103a with code and routines operable to send a request to the demultiplexer 150 to connect to an application server 115 to join a game. Although the game application 103a is described as an application, other instantiations are possible, such as a browser version. The game application 103a may receive, from the processing server 111, the VIP address associated with a demultiplexer 150, the private Internet IP address and a port number associated with a targeted application server 115a, and a token. The token is generated using a current secret key where the current secret key may be a static secret key or a dynamic secret key.

The game application 103a generates an ingress packet. In some embodiments, the ingress packet includes a routing and authentication header with the token received from the processing server 111. The client device 101 transmits the ingress packet to the VIP address associated with the demultiplexer 150.

The demultiplexer 150 includes a pepper module 151a that receives information about the current secret key from the processing application 113. For example, the pepper module 151a may receive a configuration file that includes a static secret key and a set of dynamic secret keys from the processing application 113 and updates to the configuration file. In some embodiments, the pepper module 151 may be a software daemon that runs as a background process.

The demultiplexer 150 processes the ingress packet by parsing the routing and authentication header to identify the token. The demultiplexer 150 authenticates the ingress packet by determining that the token is valid. Responsive to the token being valid, the demultiplexer 150 encapsulates the ingress packet to form an egress packet and forwards the egress packet to a targeted application server 115a that is mapped to the VIP address via the network 105.

The application servers 115 each include a game application 103 and a pepper module 151. For example, the targeted application server 115a may include game application 103b and pepper module 151b, while application server 115n may include game application 103n and pepper module 151n. The game application 103 generates a virtual experience that is provided to the client device 101.

The pepper module 151b determines the current secret key, for example, based on receiving a configuration file from the processing application 113. The targeted application server 115a receives the egress packet from the demultiplexer 150 and responds by transmitting an egress packet directly to the client device 101. In some embodiments, the demultiplexer 150, the pepper module 151, and the application servers 115 are part of the same edge data center.

While FIG. 1 illustrates one client device 101 and one processing server 111, the disclosure may apply to a system architecture having one or more client devices 101 and/or one or more processing servers 111. While FIG. 1 illustrates multiple demultiplexers 150, in some embodiments, the disclosure may apply to a system architecture having a single demultiplexer 150.

In the illustrated embodiment, the entities of the environment 100 are communicatively coupled via a network 105. The network 105 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. Although FIG. 1 illustrates one network 105 coupled to the client device 101, the processing server 111, and the application servers 115, in practice one or more networks 105 may be coupled to these entities.

### Computing Device for a Processing Application

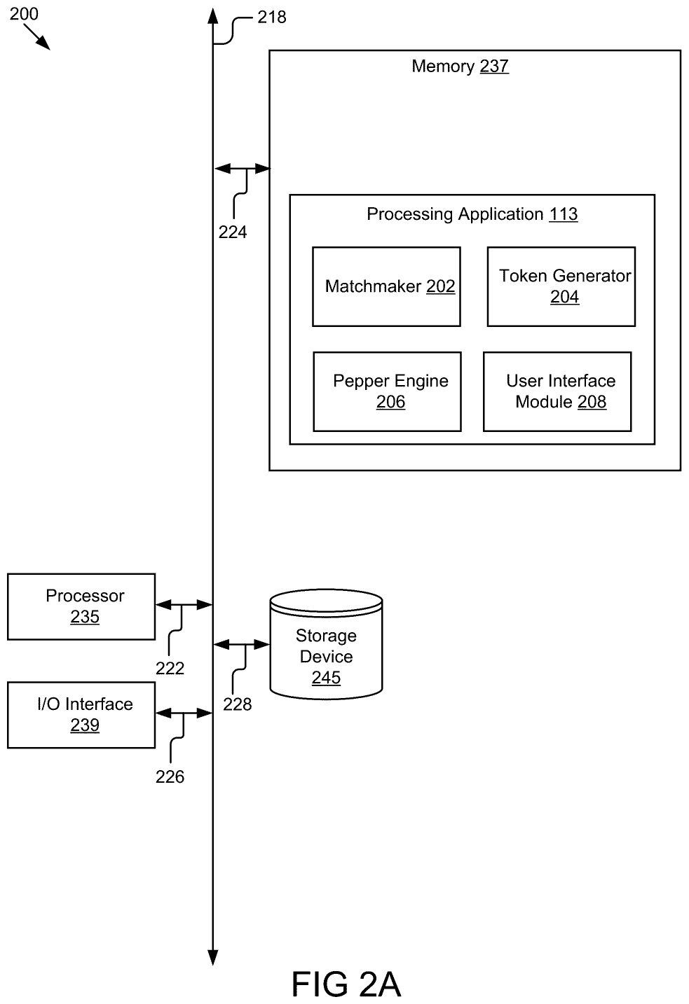

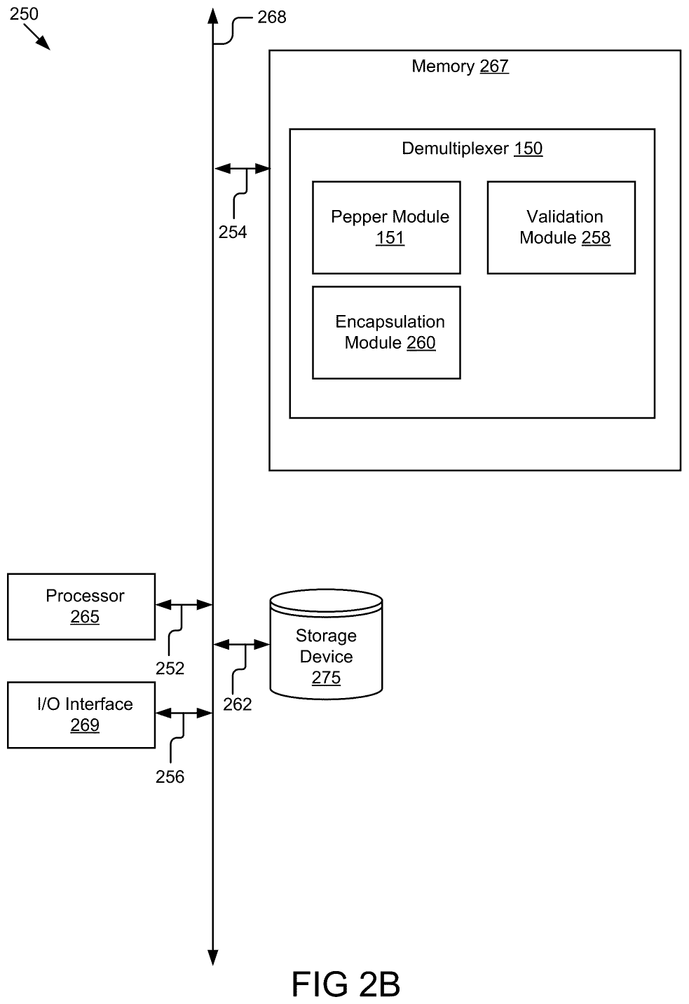

FIG. 2A is a block diagram of an example computing device 200 for a processing application 113 that may be used to implement one or more features described herein. Computing device 200 can be any suitable computer system, server, or other electronic or hardware device. In some embodiments, computing device 200 is the processing server 111.

In some embodiments, computing device 200 includes a processor 235, a memory 237, an I/O interface 239, and a storage device 245. The processor 235 may be coupled to a bus 218 via signal line 222, the memory 237 may be coupled to the bus 218 via signal line 224, the I/O interface 239 may be coupled to the bus 218 via signal line 226, and the storage device 245 may be coupled to the bus 218 via signal line 228.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200. The processor 235 is coupled to the bus 218 for communication with the other components via signal line 222.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the game application 103, which is described in greater detail below. The memory 237 is coupled to the bus 218 for communication with the other components via signal line 224.

I/O interface 239 can provide functions to enable interfacing the computing device 200 with other systems and devices. Interfaced devices can be included as part of the computing device 200 or can be separate from and communicate with the computing device 200. For example, network communication devices, storage devices (e.g., memory 237 and/or storage device 245), and input/output devices can communicate via I/O interface 239. In another example, the I/O interface 239 can receive data from the client device 101 and deliver the data to the processing application 113 and components of the processing application 113, such as the matchmaker 202. In some embodiments, the I/O interface 239 can connect to interface devices such as input devices (keyboard, pointing device, touchscreen, sensors, etc.) and/or output devices (display devices, speaker devices, printers, monitors, etc.). The I/O interface 239 is coupled to the bus 218 for communication with the other components via signal line 226.

The storage device 245 stores data related to the processing application 113. For example, the storage device 245 may store tokens, configuration files, secret keys, private IP addresses, port numbers, VIP addresses, etc. In embodiments where the processing application 113 is part of the processing server 111, the storage device 245 is the same as the data store 199 in FIG. 1.

FIG. 2A illustrates a computing device 200 that executes an example processing application 113 that includes a matchmaker 202, a token generator 204, a pepper engine 206, and a user interface module 208. Although the components of the processing application 113 are illustrated as being part of the same computing device 200, persons of ordinary skill in the art having the benefit of this disclosure will recognize that the modules may be implemented by different computing devices 200. For example, each component may be part of a separate server where each server is part of the same data center.

The matchmaker 202 receives, from the client device 101, a request to connect to an application server 115. The matchmaker 202 identifies a targeted application server 115a from a set of application servers 115a . . . n. For example, the matchmaker 202 may assign the client device 101 to the targeted application server 115a to balance loads on various application servers 115 and/or other components, based on a network proximity between the client device 101 and various available application servers 115, and/or other factors. For example, the matchmaker 202 may identify the targeted application server 115a from the set of application servers based on a client device IP address of the client device 101 and select the targeted application server 115a that is closest to a physical location of the client device 101 as compared to other application servers 115 in the set of application servers 115. The matchmaker 202 may determine the private IP address and the port number of the targeted application server 115a.

The matchmaker 202 may assign a demultiplexer 150 to handle communications with the client device 101. In some embodiments, the matchmaker 202 may assign multiple demultiplexers 150 to handle the communications with the client device 101. For example, the matchmaker 202 may map the private IP address to a VIP address for one or more demultiplexers 150 that listen for the same VIP address. The VIP address may be a public IP address.

In some embodiments, the matchmaker 202 requests a token from the token generator 204. This process is described in greater detail below with reference to the token generator 204. In some embodiments, the matchmaker 202 provides the VIP address, the private IP address, the port number, and the token to the client device 101 via the I/O interface 239. In some embodiments, the communications between the client device 101 and the matchmaker 202 occur over HyperText Transfer Protocol (HTTP) or Secure HTTP (HTTPS).

The token generator 204 generates a token. The request from the matchmaker 202 may include a private IP address and a port number for the targeted application server 115a that is assigned to the client device 101. The token generator 204 may use a cryptographic hash function that is a cryptographic Message Authentication Code (MAC) (e.g., a Hash-based MAC (HMAC)) where the token is derived from connection information, time (e.g., a timestamp), and platform-defined metadata. The token serves to provide a limited amount of platform-defined metadata for token versioning and platform-defined purposes.

In some embodiments, the token generator 204 generates a token by hashing an IP address of the client device 101, the private IP address of the targeted application server 115a, and a secret key provided by the pepper engine 206. In other embodiments, the token generator 204 generates a token by hashing the VIP address of the demultiplexer 150, the IP address of the client device 101, the private IP address of the targeted application server 115a, and the secret key. The token includes an indication of whether the token was generated using a static secret key or a particular dynamic key. For example, the indication is embedded as part of the token.

The pepper engine 206 generates a current secret key and provides the current secret key to the token generator 204, the pepper modules 151 that are associated with the demultiplexers 150, and the application servers 115. In some embodiments, by default the current secret key is a particular dynamic secret key from a set of dynamic secret keys. The current secret key may be a static secret key in instances where one of the servers 111, 115 or one of the demultiplexers 150 is taken offline either in response to maintenance, in response to a malicious network attack, or another reason.

In some embodiments, the pepper engine 206 maintains a configuration file that includes a static secret key and a set of dynamic secret keys. The set of dynamic secret keys includes dynamic secret keys that are each associated with respective generation identifiers. The dynamic secret keys may be rotated such that a different dynamic secret key is selected to be the current secret key periodically. For example, each dynamic secret key may be valid for a short period of time, for example, 10 seconds (or a minute, an hour, a day, etc.).

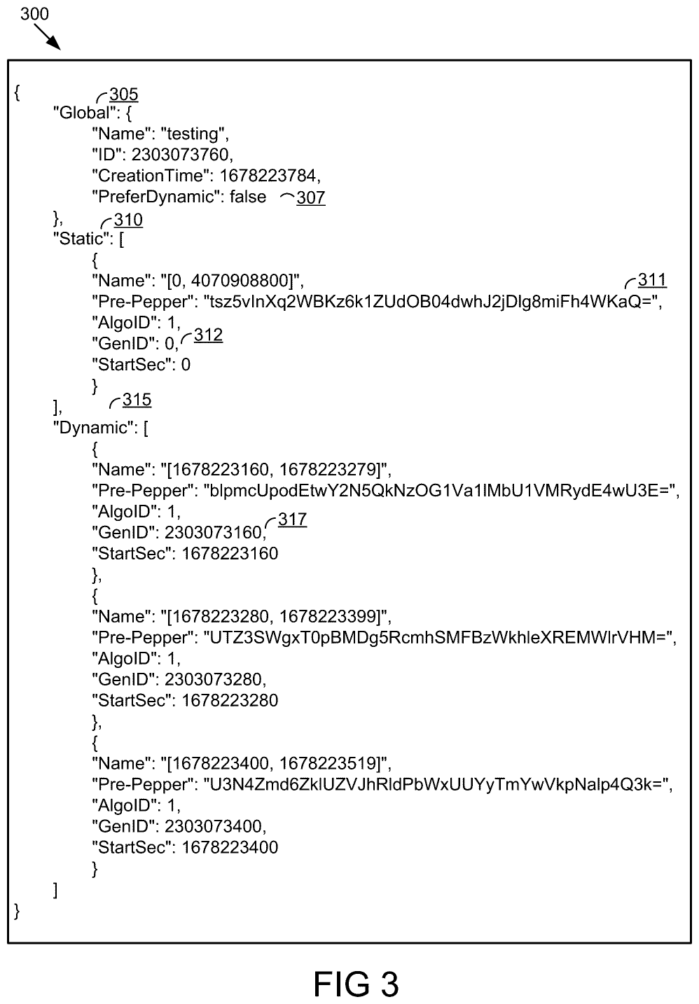

Turning to FIG. 3, an example configuration file 300 is illustrated according to some embodiments described herein. This example of the configuration file is written in C/C++, but other programming languages may be used.

The configuration file 300 includes a global field 305, a static field 310, and a dynamic field 315. The global field 305 includes global information for the configuration file 300 including a prefer dynamic field 307, which indicates whether a current secret key is a static secret key or a dynamic secret key. In this case, the prefer dynamic field 307 is set to false, signifying that the current secret key is a static secret key. If the prefer dynamic field 307 is set to true, the current secret key is a dynamic secret key. The static secret key has a generation identifier (i.e., the GenID field 312) of 0 because there is only one static secret key.

The static field 310 is for the static secret key and the dynamic field 315 includes a set of dynamic secret keys. The static secret key is generated based on the pre-petter identified in the pre-pepper field 311. The set of dynamic secret keys each include a distinct generation identifier. For example, the first dynamic secret key has 2303073160 for the GenID field 317.

The dynamic secret key may be updated to a new value at the expiration of its validity period. In some embodiments, the dynamic secret key may be selected from a set of dynamic secret keys (e.g., 1000 keys) that are rotated. In some embodiments, a new dynamic secret key may be generated at the end of each validity period. In some embodiments, the tunable window may be modified based on different factors, such as when the token generator 204 is overloaded but not experiencing bad client devices 101 (e.g., a DOS attack) to increase a length that the dynamic secret key is valid or when the processing server 111 is experiencing a DOS attack to decrease a length that the secret key is valid.

In some embodiments, the pepper engine 206 uses one or more root secrets (also known as a database master key) to generate the configuration file of a static secret key and the set of dynamic secret keys. For example, the pepper engine 206 may use a static root secret to generate a static secret key and a dynamic root secret to generate the set of dynamic secret keys. The one or more root secrets are stored in an encrypted database, such as the storage device 245. Each time the root secret is updated, the pepper engine 206 may update the configuration file and then transmit the updated configuration file to the pepper modules 151.

The pepper engine 206 may update the dynamic secret key frequently (e.g., every second, every few seconds, every millisecond, etc.) to guard against replay attacks. In some embodiments, because a large number of processing servers 111 receive updates to the dynamic secret key values, the pepper engine 206 uses a two-stage generation process where the pepper engine 206 distributes a pre-pepper (e.g., a randomly selected value) to all demultiplexers 150 and application servers 115, and each of the demultiplexers 150 and application servers 115 generate successive secret keys or use the pre-pepper to validate a secret key. In embodiments where the demultiplexers 150 and/or the applications servers 115 generate the successive secret keys, the generation may be based on the pre-pepper using a deterministic process such that each demultiplexer 150 and/or application servers 115 generate identical secret keys from identical inputs.

In some embodiments, each generation of a secret key from a pre-pepper marks a time interval for effective use of the secret key based on a timestamp. In some embodiments, each application server 115 actively requests a pre-pepper from the pepper engine 206 to support fast rotation of pre-peppers. In some embodiments, the pepper engine 206 rotates the pre-peppers based on selective parameters and administrator input. By using a pepper engine 206 as a central node to distribute pre-peppers, the technology advantageously ensures that the secret key is hidden from other components of the network environment 100.

In some embodiments, the pepper engine 206 provides the current secret to the token generator 204. The token generator 204 uses the current secret to generate the token and transmits the following information to the matchmaker 202, which relays the information to the client device 101 via the I/O interface 239: a virtual IP (VIP) address for the demultiplexer 150, the private IP address and the port number for the targeted application server 115a, and the token.

The user interface module 208 generates a user interface. In some embodiments, the user interface module 208 generates a user interface that an administrator can use to modify settings of the processing application 113. For example, the user interface may include an option for configuring how often the dynamic secret key is rotated, a list of client IP addresses that are blocked because the client device 101 failed authentication a predetermined number of times, etc.

### Computing Device for a Demultiplexer

FIG. 2B is a block diagram illustrating an example computing device 250 for a demultiplexer 150, according to some embodiments described herein.

In some embodiments, computing device 250 includes a processor 265, a memory 267, an I/O interface 269, and a storage device 275. The processor 265 may be coupled to the bus 268 via signal line 252, the memory 267 may be coupled to the bus 268 via signal line 254, the I/O interface 269 may be coupled to the bus 268 via signal line 256, and the storage device 275 may be coupled to the bus 268 via signal line 262. The processor 265, the memory 267, the I/O interface 269, and the storage device 275 may be similar to the memory 237, the processor 235, the I/O interface 239, and the storage device 245 described with reference to FIG. 2A and so will not be described herein.

FIG. 2B illustrates a computing device 200 that executes or otherwise embodies an example demultiplexer 150 that includes a pepper module 151, a validation module 258, and an encapsulation module 260.

The pepper module 151 receives a current secret key from the processing application 113. In some embodiments, the pepper module 151 receives a configuration file from the processing application 113 that includes a static secret key and a set of dynamic secret keys. In some embodiments, each of the dynamic secret keys is associated with a generation identifier.

The pepper module 151 may receive updates to the configuration file from the processing application 113 and/or periodically (or otherwise repeatedly) request a copy of the configuration file from the processing application 113. The pepper module 151 compares the updated configuration file to the previous configuration file to determine whether there is a change to the current secret key. If there is a change to the current secret key, the pepper module 151 updates the current secret key. If there is no change to the configuration file, the pepper module 151 may ignore a message containing the latest configuration file.

The validation module 258 receives the current secret key from the pepper module 151 and the ingress packet from the client device 101. In some embodiments, the client device 101 transmits the ingress packet using User Datagram Protocol (UDP). Each ingress packet may include an extensible custom application-layer header, a routing and authentication header, and a message. The routing and authentication header includes the private IP address and the port number for the targeted application server 115a, as well as the token. In some embodiments, the routing and authentication header also includes an indication of whether the token was generated using the static secret key or a particular dynamic secret key. For example, the encoded token may include an encoded field that identifies whether the dynamic or static secret key was used and the dynamic secret key was used, there may be an additional encoded field that identifies which generation of the secret was used. The header may be extensible to enable additional demultiplexer functionality in the future.

After receipt of an ingress packet, the validation module 258 checks the routing and authentication header. If the ingress packet is lacking the routing and authentication header or the routing and authentication head is malformed, the validation module 258 discards the ingress packet. If the routing and authentication header is present and not malformed, the validation module 258 parses the routing and authentication layer to extract the private IP address and the port number for the targeted application server 115a, as well as the token.

The validation module 258 performs authentication of the token. For example, the token includes an indication of whether the token was generated using a static secret key or a dynamic secret key. The validation module 258 identifies the current secret key based on the indication. In some embodiments, the token also includes a generation identifier. If the validation module 258 determines that the current secret key is a dynamic secret key, the validation module 258 uses the generation identifier to determine a particular dynamic secret key from a set of dynamic secret keys. For example, referring to FIG. 3, if the generation identifier is “2303073160,” the current secret key is associated with the first dynamic secret key and the secret (i.e., the pepper) is “blpmcUpodEtwY2N5QkNzOG1VallMbUlVMkRydE4wU3E=.”

The validation module 258 validates the token by generating a hash of the client device IP address, the private IP address, and the current secret key and compares the token to the hash to confirm that both the token and the hash have equal values. If the validation module 258 determines that the token is invalid, the validation module 258 may drop the ingress packet. This protects the system from a distributed DoS (DDOS) attack. In some embodiments, the validation module 258 may drop future ingress packets from the same client device 101 or automatically block the IP address of the client device 101. For example, the validation module 258 may stream data about attributes of the ingress packets that fail token validation, resulting in the validation module 258 using a list of client devices 101 that are given persistent-drop treatment (e.g., where the list is an Access Control List). In some embodiments, the demultiplexer 150 sends a notification to the client device 101 that the ingress packet is invalid.

If the validation module 258 determines that the token is valid, the validation module 258 provides the ingress packet to the encapsulation module 260. The encapsulation module 260 may identify the targeted application server 115a using the private IP address and the port number and encapsulates the ingress packet to form an egress packet.

The encapsulation module 260 may forward the egress packet to the targeted application server 115a by using an encrypted tunnel. The encrypted tunnel prevents interception of communications between the client device 101 and the targeted application server 115a. The demultiplexer 150 may encapsulate the ingress packet in a tunnel header of type Generic UDP Encapsulation (GUE) header. The egress packet may include an extensible custom application-layer header, a GUE header, and the message. In some embodiments, receiving the ingress packet at the VIP address and transmitting the egress packet to the targeted application server 115a occur using UDP.

In some embodiments, once the targeted application server 115a receives the egress packet, the targeted application server 115a communicates directly with the client device 101 without the demultiplexer 150 serving as an intermediary.

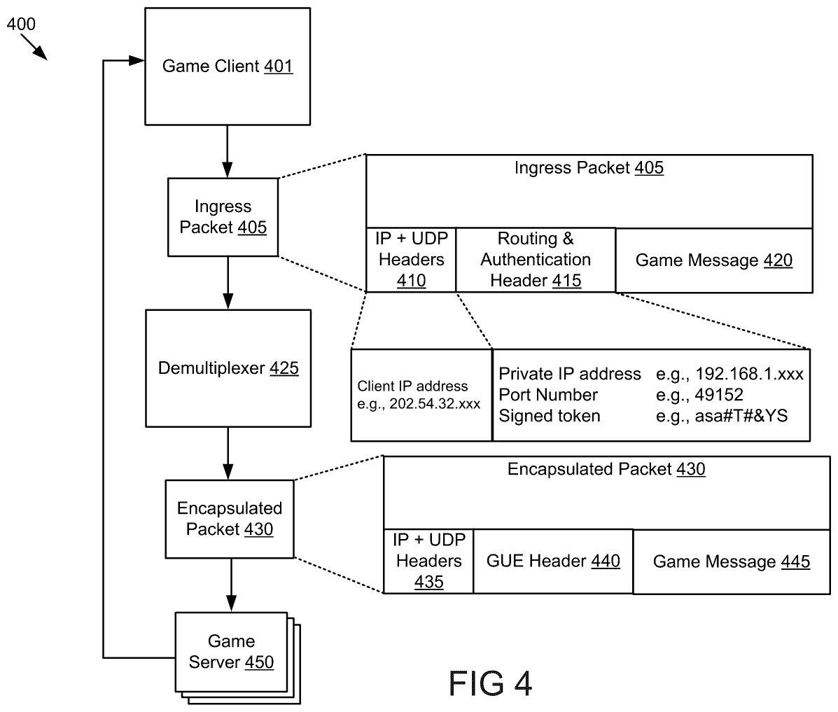

Turning to FIG. 4, an example use case 400 between a game client 401 and a game server 450 is illustrated. Although the example use case 400 is for a game client and a game server, persons of ordinary skill in the art having the benefit of this disclosure will recognize that this process could apply to any situation where a client device is trying to access one of many application servers and a demultiplexer serves as an intermediary to prevent the risk of DDOS attacks, which may not necessarily involve a game-related embodiment, use scenario, etc.

In this example, a game client 401 generates an ingress packet 405 and transmits the ingress packet 405 to the demultiplexer 425. The ingress packet 405 may include IP+UDP headers 410, a routing and authentication header 415, and a game message 420. The IP+UDP headers 410 include a client IP address. The routing and authentication header 415 includes a private IP address for the game server 450, a port number, and a signed token. In some embodiments, a game message 420 may be a Raknet based message. While RakNet is one UDP-based application protocol that may be used, other UDP-based non-Raknet applications can also be similarly used.

The demultiplexer 425 receives the ingress packet 405, parses the routing and authentication header 415 for the IP address, the port number, and the token. The demultiplexer 425 authenticates the token and, if the token is valid, generates an encapsulated packet 430 from the ingress packet 405. The encapsulated packet 430 includes IP+UDP headers 435, a GUE header 440, and the game message 445. The demultiplexer 425 transmits the encapsulated packet 430 to the game server 450. The game server 450 then directly communicates with the game client 401.

In some embodiments, the demultiplexer 425 is one of multiple demultiplexers 425 that are mapped to the same VIP address. The network 105 may shard the incoming packets among the multiple demultiplexers 425 as part of a horizontally scaled setup. In some embodiments, the network 105 uses the common routing protocol Border Gateway Protocol (BGP) with Equal Cost Multi Path (ECMP) hashing (or other suitable techniques) to shard the ingress packets evenly among the demultiplexers 425. The ingress packets are divided without the need for synchronizing per-flow state between the multiple demultiplexers 425 that are part of the horizontally scaled setup.

In some embodiments, each demultiplexer 425 receives the secret key and uses it to authenticate the token. As a result, the demultiplexer 425 that processed an initial request is not the only demultiplexer 425 capable of performing authentication. Any of the demultiplexers 425 are capable of performing authentication using the secret key and the ingress packet transmitted by the client device 101.

One advantage of the demultiplexer 150 is that its stateless nature allows game traffic from client devices 101 to arrive at any of the Point of Presence (POP) edge data centers and the game traffic will be forwarded to the correct application server 115 in whichever POP is in the network 105. As a result, the VIPs can be successfully used in a global anycast fashion.

The use of the VIP address along with the stateless nature of the demultiplexer 150 enabled by the routing and authentication header provides another attractive property: namely the ability to steer traffic on a per-user basis to a specific ingress POP—an edge data center that hosts application servers 115 in the global network 105. Internet routing on parts of the internet owned by other network providers, including where the client device 101 may be connected, might otherwise have caused traffic from the specific client device 101 to ingress into the network 105 at a different POP to reach the same application server 115. Instead, this steering to specific PoPs might be done to provide a better network experience, for example, because a specific application server 115 may be selected for lower latency or lower network congestion to specific client devices 101 by various techniques including backhauling over the network 105 to the specific POP where the application server 115 is located.

The use of the VIP address with the demultiplexer 150 enables global IPv4 address space conservation in that the application servers 115 do not themselves need to have a per-application server 115 global IPv4 address and can just be numbered with RFC1918 private addresses on their network interface. An entire POP of application servers 115 could thus be abstracted behind a single per-POP VIP address. Alternatively or additionally, there may be multiple VIP addresses in use on a horizontally scaled demultiplexer 150 pool to enable partitioning of the traffic for network management or for capacity planning.

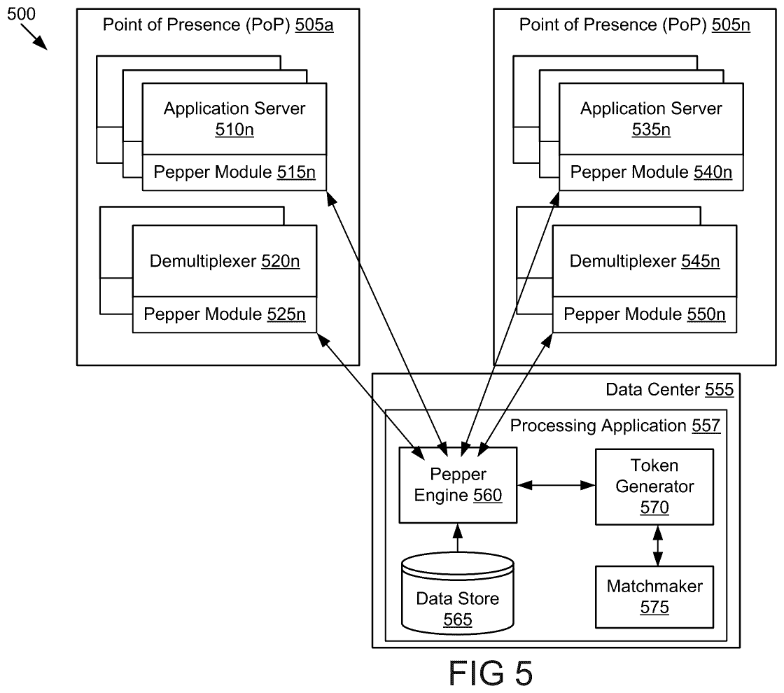

FIG. 5 is a block diagram illustrating an example architecture 500 for synchronizing a secret key, according to some embodiments described herein. The architecture 500 includes a first Point of Presence (POP) edge data center 505a and an nth POP edge data center 505n. The first PoP 505a includes a set of application servers 510n with corresponding pepper modules 515n and a set of demultiplexers 520n with corresponding pepper modules 525n. The nth PoP 505n includes a set of application servers 535n with corresponding pepper modules 540n and a set of demultiplexers 545n with corresponding pepper modules 550n.

A data center 555 includes a processing application 557. The processing application 557 includes a pepper engine 560, a data store 565, a token generator 570, and a matchmaker 575. The pepper engine 560 receives a root secret from the data store 565, which includes encrypted root secrets for a static secret key and for a dynamic secret key. The pepper engine 560 generates the static secret key and a set of dynamic secret keys based on the corresponding root secrets. The pepper engine 560 may generate a configuration file that includes the static secret key and the set of dynamic secret keys along with other information, such as a generation identifier for each of the dynamic secret keys.

The pepper engine 560 transmits a current secret key either directly or as a configuration file to the pepper modules 515n, 540n, 525n, 550n. As a result of this architecture 500, the components support auto-scaling to accommodate additional application servers and additional demultiplexers. The data store 565 periodically provides a new root secret to the pepper engine 560. The pepper engine 560 may generate an updated configuration file based on the new root secret. The pepper engine 560 transmits the updated configuration file to the pepper modules 515n, 540n, 525n, 550n.

In some embodiments, the data center 555 may be taken offline. For example, the data center 555 may be taken offline for scheduled maintenance or in response to an administrator starting the process of taking the data center 555 offline. The pepper engine 560 transmits a notification to the pepper modules 515n, 540n, 525n, 550n to update the current secret key from being the dynamic secret key to the static secret key. In some embodiments, the pepper engine 560 transmits the notification as a configuration file that indicates the static secret key should be used for generating tokens to the pepper modules 515n, 540n, 525n, 550n. For example, the configuration file has the prefer dynamic field set to false.

In some embodiments, one of the other components of the architecture 500 may be disconnected from the other components and therefore offline. For example, the pepper module 525n associated with the demultiplexer 520n may be unable to communicate with the pepper engine 560. In this scenario, the demultiplexer 520n reverts to using the static secret key during authentication to prevent a disruption of service. Similarly, if the pepper module 515n associated with the application server 510n is unable to communicate with the pepper engine 560, the application server 510n generates egress packets based on the static secret key.

In some embodiments, when one of the components of the architecture 500 goes back online, the pepper engine 560 may perform a multi-step transition. First the pepper engine 560 generates a new configuration file and transmits the updated configuration file to the pepper modules 515n, 540n, 525n, 550n. The pepper engine 560 generates tokens with the static secret key where the token includes an indication that verification of the token may be performed using either the static secret key or the dynamic secret key. Second, the pepper engine 560 generates tokens using the dynamic secret key where the token includes an indication that verification of the token may be performed using either the static secret key or the dynamic secret key. Further, the pepper engine 560 generates tokens using the dynamic secret key where the token includes an indication that verification of the token is to be performed using the dynamic secret key. As a result, the pepper engine 560 dynamically updates the current secret during an attack by rendering previously copies packets invalid and useless to malicious actors.

### Methods

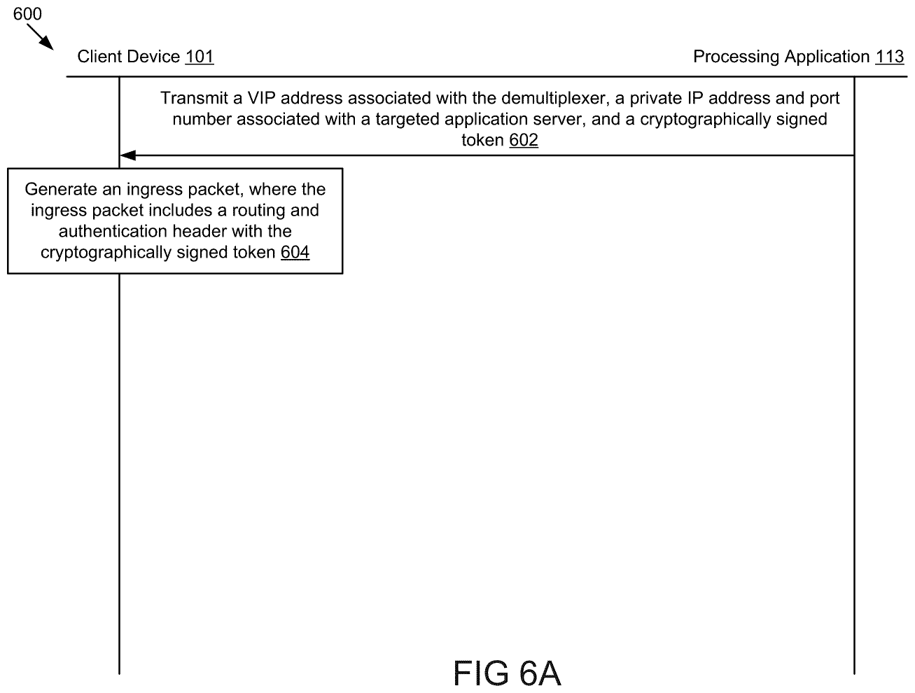

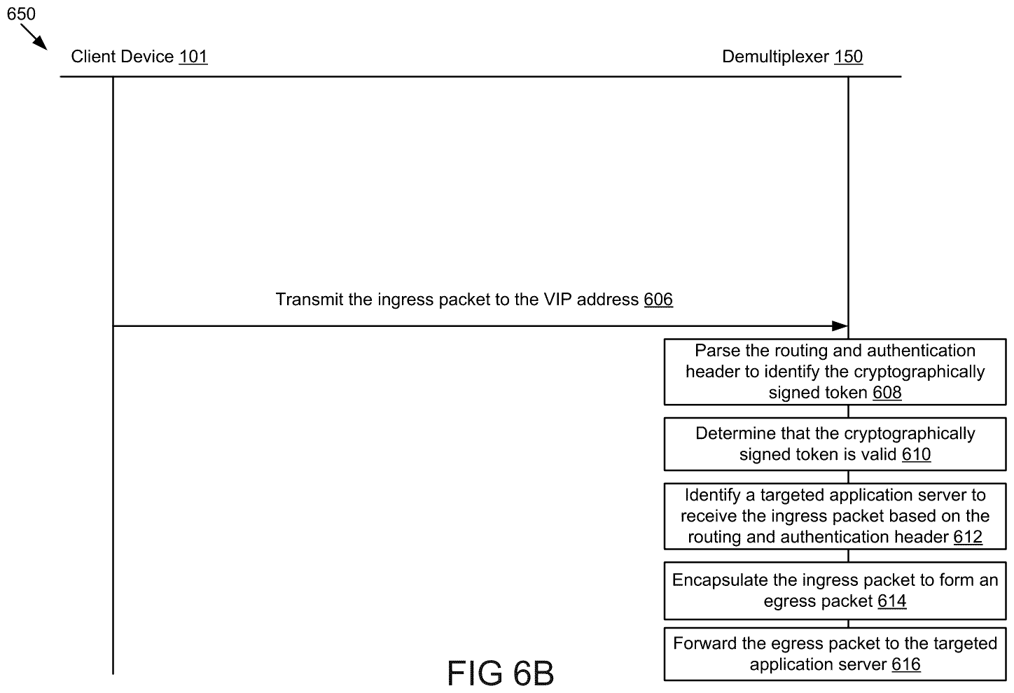

FIGS. 6A-6B are example flow diagrams of a method 600, 650 between a client device, a processing application, and a demultiplexer, according to some embodiments. The method 600 illustrated in FIG. 6A is performed by both a client device 101 and a processing application 113. The method 650 illustrated in FIG. 6B is performed by both the client device 101 and a demultiplexer 150.

The method 600 may begin at block 602. At block 602, the processing server 111 (e.g., the matchmaker 202) transmits a VIP address associated with the demultiplexer 150, a private IP address and port number associated with a targeted application server 115a, and a token to the client device 101. Block 602 may be followed by block 604.

At block 604, the client device 101 generates an ingress packet, where the ingress packet includes a routing and authentication header with the token. Block 604 may be followed by block 606.

At block 606, the client device 101 transmits the ingress packet to the VIP address associated with the demultiplexer 150. Block 606 may be followed by block 608.

At block 608, the demultiplexer 150 parses the routing and authentication header to identify the token. Block 608 may be followed by block 610. At block 610, the demultiplexer 150 determines that the token is valid. Block 610 may be followed by block 612. At block 612, the demultiplexer 150 may identify a targeted application server 115a to receive the ingress packet based on the routing and authentication header. Block 612 may be followed by block 614. At block 614, the demultiplexer 150 encapsulates the ingress packet to form an egress packet. Block 614 may be followed by block 616. At block 616, the demultiplexer 150 forwards the egress packet to the targeted application server 115a.

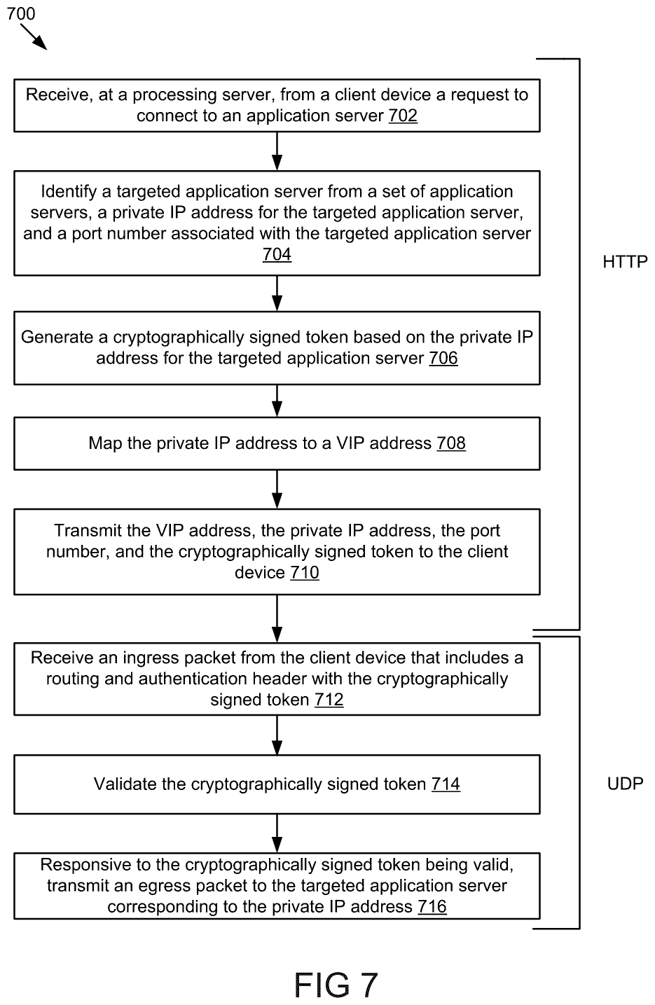

FIG. 7 is a flow diagram of an example method 700 written from the processing server 111 perspective and the demultiplexer 150 perspective, according to some embodiments described therein. The method 700 may be performed by the computing device 200 in FIG. 2A and the computing device 250 in FIGS. 2B.

The method 700 may begin at block 702. At block 702, a processing server 111 receives from a client device 101 a request to connect to an application server 115. For example, the request may include a request to join a particular game. Block 702 may be followed by block 704.

At block 704, a targeted application server 115a is identified from a set of application servers 115, a private IP address for the targeted application server 115, and a port number associated with the targeted application server 115. Block 704 may be followed by block 706.

At block 706, a cryptographically signed token is generated based on the private IP address for the targeted application server 115. Block 706 may be followed by block 708.

At block 708, the private IP address is mapped to a VIP address. Block 708 may be followed by block 710.

At block 710, the VIP address, the private IP address, the port number, and the cryptographically signed token are transmitted to the client device 101. In some embodiments. blocks 702-710 are performed over HTTP at the processing server 111. Block 710 may be followed by 712.

At block 712, an ingress packet is received from the client device that includes a routing and authentication header with the cryptographically signed token. Block 712 may be followed by block 714.

At block 714, the token is validated. Block 714 may be followed by block 716.

At block 716, responsive to the cryptographically signed token being valid, an egress packet is transmitted to the targeted application server 115a corresponding to the private IP address. In some embodiments, blocks 712-716 are performed over UDP at the demultiplexer 150.

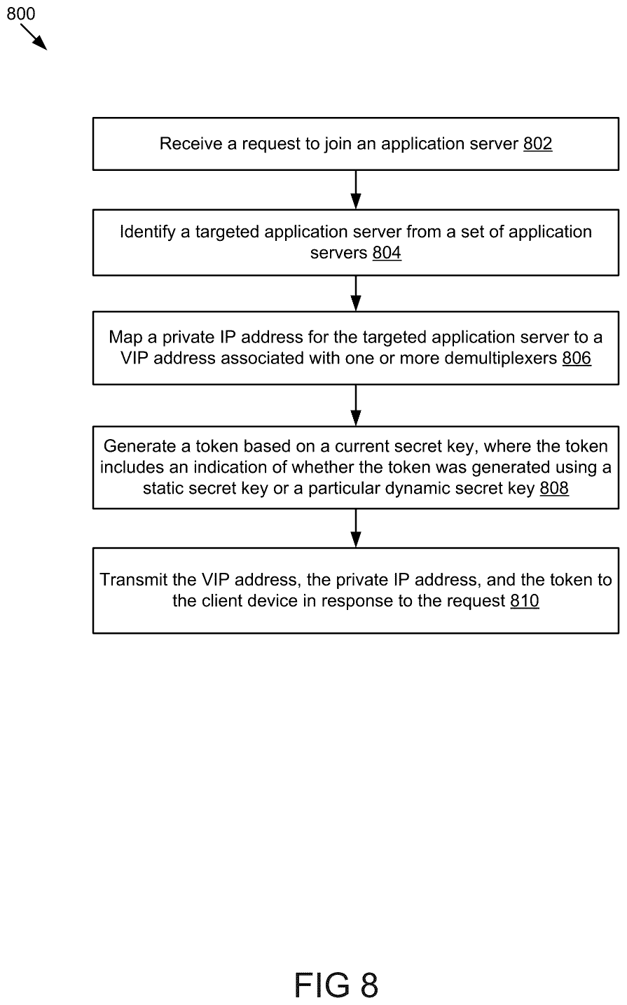

FIG. 8 is a flow diagram of an example method 800 written from the processing server 111 perspective, according to some embodiments described therein. The method 800 may be performed by the computing device 200 in FIG. 2A.

The method 800 may begin at block 802. At block 802, a request to connect to an application server is received. For example, the request may be a request to join a particular game. Block 802 may be followed by block 804.

At block 804, a targeted application is identified from a set of application servers. Identifying the targeted application server from the set of application servers may be based on a client device IP address of the client device and selecting the targeted application server that is closest to a physical location of the client device as compared to other application servers in the set of application servers. Block 804 may be followed by block 806.

At block 806, a private IP address for the targeted application server is mapped to a VIP address associated with one or more demultiplexers. Block 806 may be followed by block 808.

At block 808, a token is generated based on a current secret key, where the token includes an indication of whether the token was generated using a static secret key or a particular dynamic secret key. The token may also include a generation identifier for the current secret key and wherein responsive to the current secret key being the particular dynamic secret key, the generation identifier refers to the particular dynamic secret key from a set of dynamic secret keys. The token may be a hash of a client device IP address of the client device, the private IP address for the targeted application server, and the current secret key. Block 808 may be followed by block 810.

At block 810, the VIP address, the private IP address, and the token are transmitted to the client device in response to the request.

The method 800 may also include transmitting, to the one or more demultiplexers and the set of application servers, a configuration file that includes the static secret key and a set of dynamic secret keys including the particular dynamic secret key, where each dynamic secret key in the set of dynamic secret keys is associated with a corresponding generation identifier. The method 800 may further include updating the configuration file based on a change to a root static secret and a change to a root dynamic static secret and transmitting the updated configuration file to the one or more demultiplexers and the set of application servers. The method 800 may further include in response to an upcoming offline status of the processing server, transmitting a notification to the one or more demultiplexers to perform validation of tokens from using the particular dynamic secret key to using the static secret key.

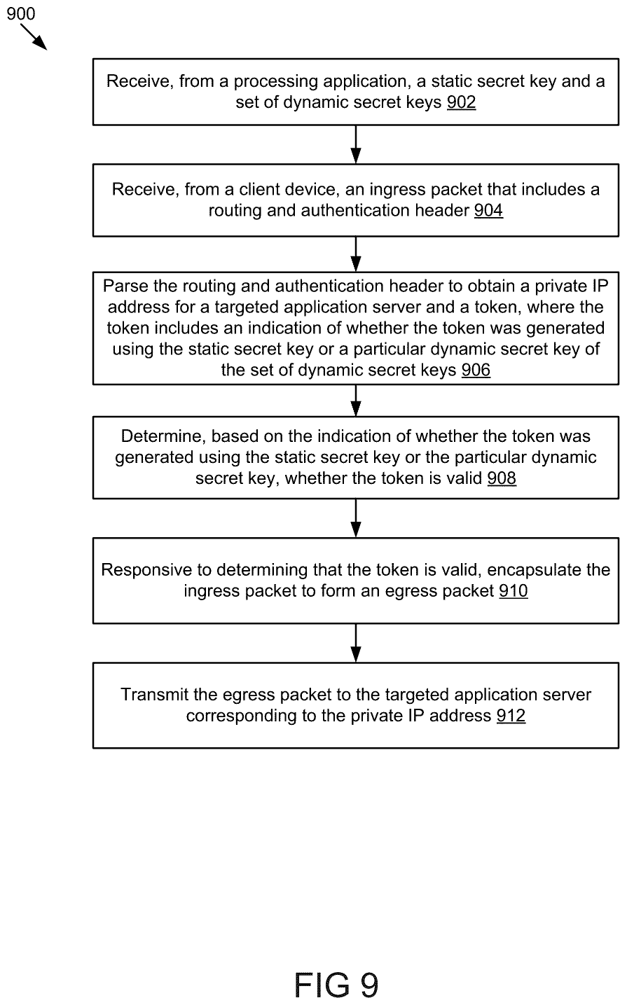

FIG. 9 is a flow diagram of an example method 900 written from the demultiplexer 150 perspective, according to some embodiments described therein. The method 900 may be performed by the computing device 250 in FIG. 2B.

The method 900 may begin with block 902. At block 902, a static secret key and a set of dynamic secret keys are received from a processing application. The static secret key and the set of dynamic secret keys may be received as a configuration file. Block 902 may be followed by block 904.

At block 904, an ingress packet that includes a routing and authentication header is received from a client device. Block 904 may be followed by block 906.

At block 906, the routing and authentication header is parsed to obtain a private IP address for a targeted application server and a token, where the token includes an indication of whether the token was generated using the static secret key or a particular dynamic secret key of the set of dynamic secret keys. The token may be encoded with a generation identifier for the particular dynamic secret key and wherein determining whether the token is valid is further based on the generation identifier. Block 906 may be followed by block 908.

At block 908, it is determined, based on the indication of whether the token was generated using the static secret key or the particular dynamic secret key, whether the token is valid. Determining whether the token is valid may include calculating a hash of a client device IP address, the private IP address for the targeted application server, and the static secret key or the particular dynamic secret key based on the indication and comparing the token to the hash to confirm that both the token and the hash have equal values. Block 908 may be followed by block 910.

At block 910, responsive to determining that the token is valid, the ingress packet in encapsulated to form an egress packet. The method 900 may further include responsive to determining that the token is invalid, performing one or more of dropping future ingress packets from the client device or automatically blocking a client device IP address. Block 910 may be followed by block 912.

At block 912, the egress packet is transmitted to the targeted application server corresponding to the private IP address. Transmitting the egress packet to the targeted application server may include using a tunnel to forward the egress packet.

The method 900 may also include receiving, from the processing server, an update to the configuration file and performing subsequent validations of tokens based on the update to the configuration file. The demultiplexer may be one of a plurality of demultiplexers mapped to a VIP address, incoming packets may be sharded among the plurality of demultiplexers, and each of the plurality of demultiplexers receives a configuration file that includes the static secret key and set of dynamic secret keys. The method 900 may also include receiving a notification from a processing server to perform a first validation of tokens using the static secret key and, responsive to the first validation failing, perform a second validation of the tokens using the particular dynamic secret key.

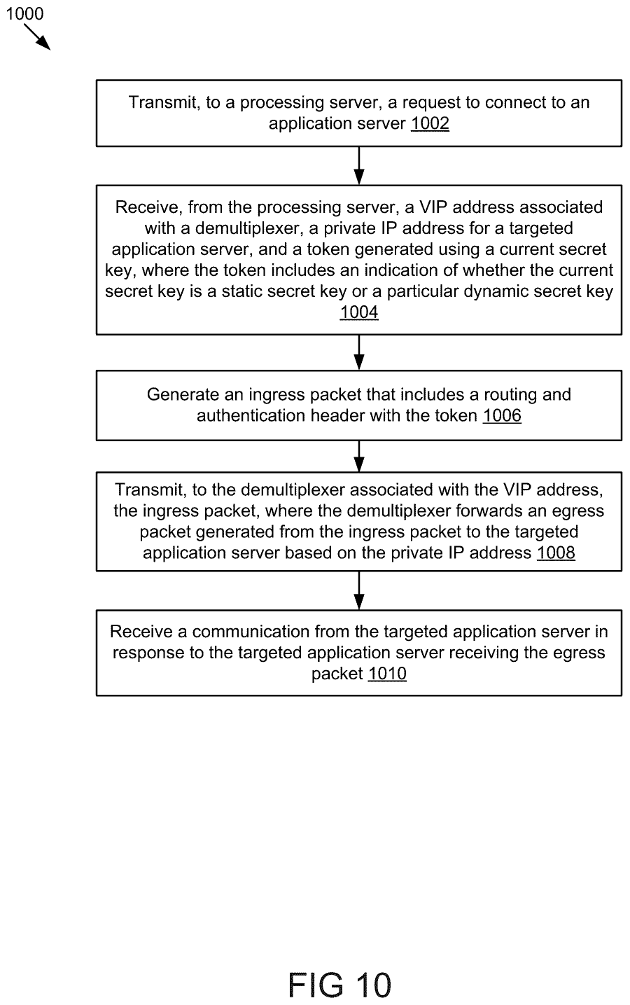

FIG. 10 is a flow diagram of an example method 1000 written from the client device 101 perspective, according to some embodiments described therein.

The method 1000 may begin at block 1002. At block 1002, a request to connect to an application server is transmitted to a processing server. Block 1002 may be followed by block 1004.

At block 1004, a VIP address associated with a demultiplexer, a private IP address for a targeted application server, and a token generated using a current secret key are received from the processing server, where the token includes an indication of whether the current secret key is a static secret key or a particular dynamic secret key. The token may further include a generation identifier for the current secret key and wherein responsive to the current secret key being the particular dynamic secret key, the generation identifier refers to the particular dynamic secret key from a set of dynamic secret keys. Block 1004 may be followed by block 1006.

At block 1006, an ingress packet that includes a routing and authentication header with the token is generated. Block 1006 may be followed by block 1008.

At block 1008, the ingress packet is transmitted to the demultiplexer associated with the VIP address, where the demultiplexer forwards an egress packet generated from the ingress packet to the targeted application server based on the private IP address. The demultiplexer forwards the egress packet responsive to determining, using the current secret key, that the token is valid. Block 1008 may be followed by block 1010.

At block 1010, a communication is received from the targeted application server in response to the targeted application server receiving the egress packet. The client device may transmit the request to connect to the application server using HTTP and the client device may transmit the ingress packet to the demultiplexer using UDP.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, some of the blocks may be modified, eliminated, supplemented with other blocks, combined, etc. In some embodiments, blocks and operations can be performed multiple times, in a different order, and/or at different times in the methods.

In the above description, for purposes of explanation, numerous specific details are set forth in order to provide a thorough understanding of the specification. The disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are usable by those of ordinary skill in the data processing arts to most effectively convey the substance of their work to others. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method performed at a processing server, the method comprising:
receiving, from a client device, a request to connect to an application server;
identifying a targeted application server from a set of application servers;
mapping a private internet protocol (IP) address for the targeted application server to a virtual IP (VIP) address associated with one or more demultiplexers;
generating a token based on a current secret key, wherein the token includes an indication of whether the token was generated using a static secret key or a particular dynamic secret key; and
transmitting the VIP address, the private IP address, and the token to the client device in response to the request.

2. The method of claim 1, wherein the token further includes a generation identifier for the current secret key and wherein responsive to the current secret key being the particular dynamic secret key, the generation identifier refers to the particular dynamic secret key from a set of dynamic secret keys.

3. The method of claim 1, further comprising:
transmitting, to the one or more demultiplexers and the set of application servers, a configuration file that includes the static secret key and a set of dynamic secret keys including the particular dynamic secret key;
wherein each dynamic secret key in the set of dynamic secret keys is associated with a corresponding generation identifier.

4. The method of claim 3, further comprising:
updating the configuration file based on a change to a root static secret and a change to a root dynamic static secret; and
transmitting the updated configuration file to the one or more demultiplexers and the set of application servers.

5. The method of claim 1, further comprising:
in response to an upcoming offline status of the processing server, transmitting a notification to the one or more demultiplexers to perform validation of tokens from using the particular dynamic secret key to using the static secret key.

6. The method of claim 1, wherein the token includes a hash of a client device IP address of the client device, the private IP address for the targeted application server, and the current secret key.

7. The method of claim 1, wherein identifying the targeted application server from the set of application servers is based on a client device IP address of the client device and selecting the targeted application server that is closest to a physical location of the client device as compared to other application servers in the set of application servers.

8. A demultiplexer comprising:
one or more processors; and
a memory coupled to the one or more processors, with instructions stored thereon that, when executed by the one or more processors, cause the one or more processors to perform or cause to be performed operations comprising:
receiving, from a processing server, a static secret key and a set of dynamic secret keys;
receiving, from a client device, an ingress packet that includes a routing and authentication header;
parsing the routing and authentication header to obtain a private Internet Protocol (IP) address for a targeted application server and a token, wherein the token includes an indication of whether the token was generated using the static secret key or a particular dynamic secret key of the set of dynamic secret keys;
determining, based on the indication of whether the token was generated using the static secret key or the particular dynamic secret key, whether the token is valid;
responsive to determining that the token is valid, encapsulating the ingress packet to form an egress packet; and
transmitting the egress packet to the targeted application server corresponding to the private IP address.

9. The demultiplexer of claim 8, wherein the token is encoded with a generation identifier for the particular dynamic secret key and wherein determining whether the token is valid is further based on the generation identifier.

10. The demultiplexer of claim 8, wherein receiving the static secret key and the set of dynamic secret keys includes receiving the static secret key and the set of dynamic secret keys as part of a configuration file.

11. The demultiplexer of claim 10, wherein the operations further include:
receiving, from the processing server, an update to the configuration file; and
performing subsequent validations of tokens based on the update to the configuration file.

12. The demultiplexer of claim 8, wherein determining whether the token is valid includes:
calculating a hash of a client device IP address, the private IP address for the targeted application server, and the static secret key or the particular dynamic secret key based on the indication; and
comparing the token to the hash to confirm that both the token and the hash have equal values.

13. The demultiplexer of claim 8, wherein transmitting the egress packet to the targeted application server includes using a tunnel to forward the egress packet.

14. The demultiplexer of claim 8, wherein the operations further include:
responsive to determining that the token is invalid, performing one or more of dropping future ingress packets from the client device or automatically blocking a client device IP address.

15. The demultiplexer of claim 8, wherein:
the demultiplexer is one of a plurality of demultiplexers mapped to a Virtual IP (VIP) address;
incoming packets are sharded among the plurality of demultiplexers; and
each of the plurality of demultiplexers receives a configuration file that includes the static secret key and set of dynamic secret keys.

16. The demultiplexer of claim 8, wherein the operations further include:
receiving a notification from a processing server to perform a first validation of tokens using the static secret key and, responsive to the first validation failing, perform a second validation of the tokens using the particular dynamic secret key.

17. A non-transitory computer-readable medium with instructions stored thereon that, when executed by a client device, cause the client device to perform or cause to be performed operations, the operations comprising:
transmitting, to a processing server, a request to connect to an application server;
receiving, from the processing server, a Virtual Internet Protocol (VIP) address associated with a demultiplexer, a private Internet Protocol (IP) address for a targeted application server, and a token generated using a current secret key, where the token includes an indication of whether the current secret key is a static secret key or a particular dynamic secret key;
generating an ingress packet that includes a routing and authentication header with the token;
transmitting, to the demultiplexer associated with the VIP address, the ingress packet, wherein the demultiplexer forwards an egress packet generated from the ingress packet to the targeted application server based on the private IP address; and
receiving a communication from the targeted application server in response to the targeted application server receiving the egress packet.

18. The computer-readable medium of claim 17, wherein the client device transmits the request to connect to the application server using HyperText Transfer Protocol (HTTP) and wherein the client device transmits the ingress packet to the demultiplexer using User Datagram Protocol (UDP).

19. The computer-readable medium of claim 17, wherein the token further includes a generation identifier for the current secret key and wherein responsive to the current secret key being the particular dynamic secret key, the generation identifier refers to the particular dynamic secret key from a set of dynamic secret keys.

20. The computer-readable medium of claim 17, wherein the demultiplexer forwards the egress packet responsive to determining, using the current secret key, that the token is valid.
